(19) United States
(12) Patent Application Publication
(10) Pub. No.: US 2011/0167388 A1
(43) Pub. Date: Jul. 7, 2011

(54) ELECTRONIC DEVICE AND METHOD OF BROWSING IMAGES THEREON

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/697,222

(22) Filed: Jan. 30, 2010

(30) Foreign Application Priority Data
Jan. 4, 2010 (CN) 201010300029.3

(51) Int. Cl. G06F 3/048; G09G 5/00

(52) U.S. Cl. 715/830; 345/660

(57) ABSTRACT

A method of browsing images on an electronic device is disclosed. The method includes confirming a first distance in which an image is desired to be moved. The image is moved a second distance along a first direction. The second distance is shorter than the first distance. The image is displayed at the second distance. A location module determines whether the image has moved the first distance. If the image has not moved the first distance, the method repeats the step of moving the image the second distance.

### BACKGROUND

1. Technical Field

The present disclosure relates to an electronic device and a method of smoothly browsing images on the electronic device.

2. Description of Related Art

Embedded electronic devices (such as digital photo frames) allow browsing of images by a remote controller. However, images can only be browsed one by one through a button on the remote controller, and the movement is instantaneous, as one image is moved from one position to another position.

### BRIEF DESCRIPTION OF THE DRAWINGS

FIG. 1 is a block diagram of an electronic device in accordance with one embodiment.

FIG. 2 is a schematic view of images displaying on a display.

FIG. 3 is a first schematic view of the images moving of FIG. 2.

FIG. 4 is a second schematic view of the images moving of FIG. 2.

FIG. 5 is a third schematic view of the images moving of FIG. 2.

FIG. 6 is a flowchart of a method of browsing images smoothly on an electronic device, such as, for example, that of FIG. 1.

FIG. 7 is a schematic view of the display of the electronic device of FIG. 1.

FIG. 8 is a schematic view of the images moving of FIG. 7.

FIG. 9 is a schematic view of the display after the images moves.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

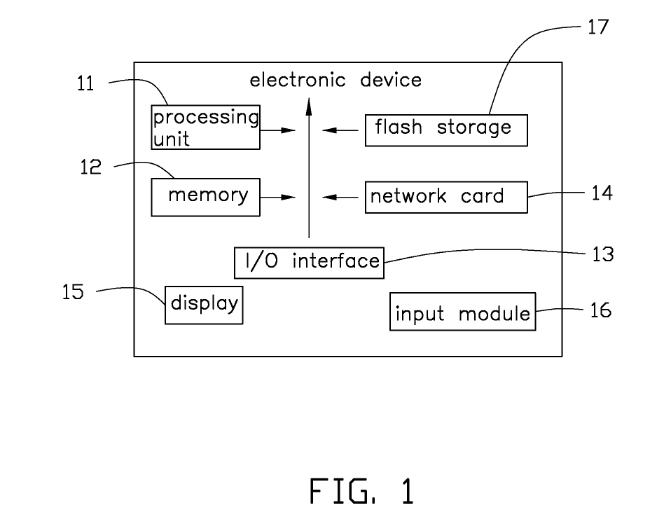

Referring to FIG. 1, an electronic device includes a processing unit 11, a memory 12, an Input/Output (I/O) interface 13, a network card 14, a display 15, an input module 16 and a flash storage 17. The display 15 displays a user interface. The input module 16 may be a remote controller. The electronic device may be a digital photo frame, a media player, or a personal computer.

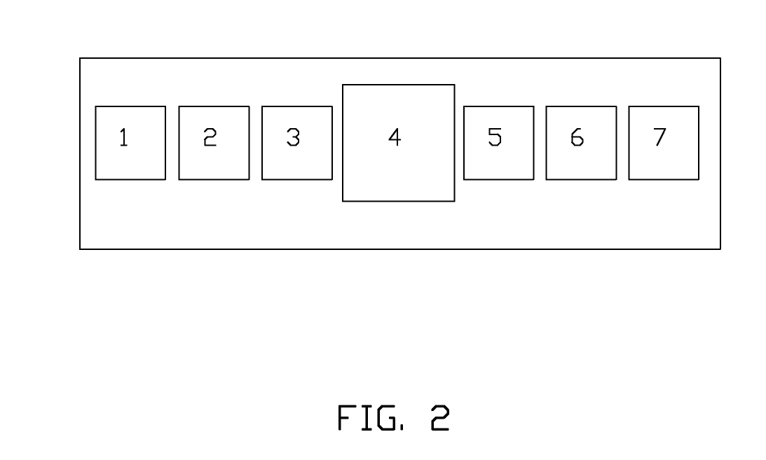

Referring to FIG. 2, the electronic device includes an initializing module, a location module and a display module. The initializing module establishes the flash storage 17 storing a number N of images. Image number may be defined from 1 to N. The initializing module defines a position of each image on the display 15. The initializing module initializes an image number G, and the number G of images is shown on the display 15. In one embodiment, G=7. Additionally, the images may be icons.

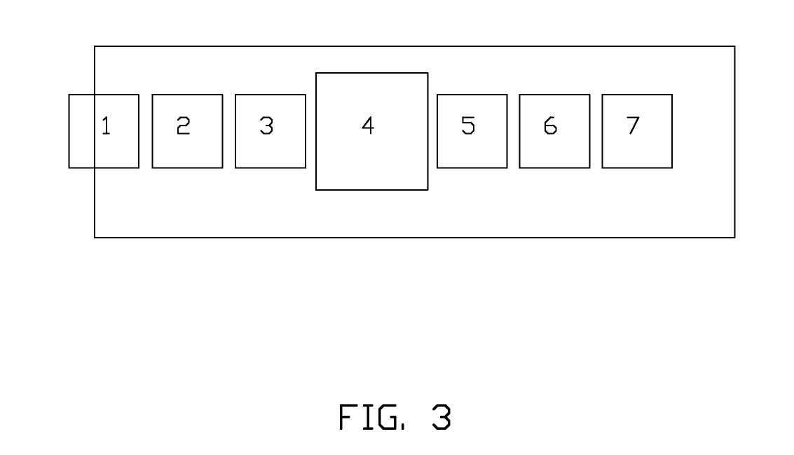

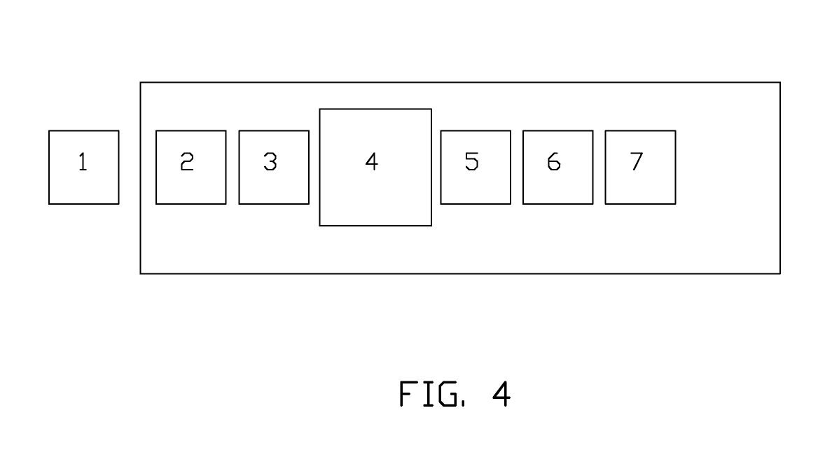

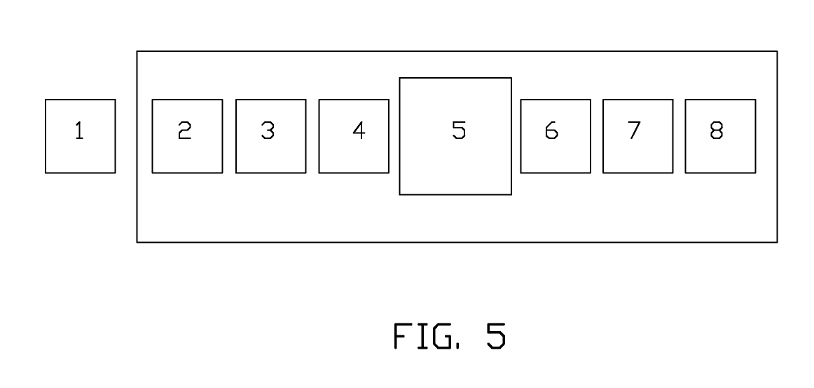

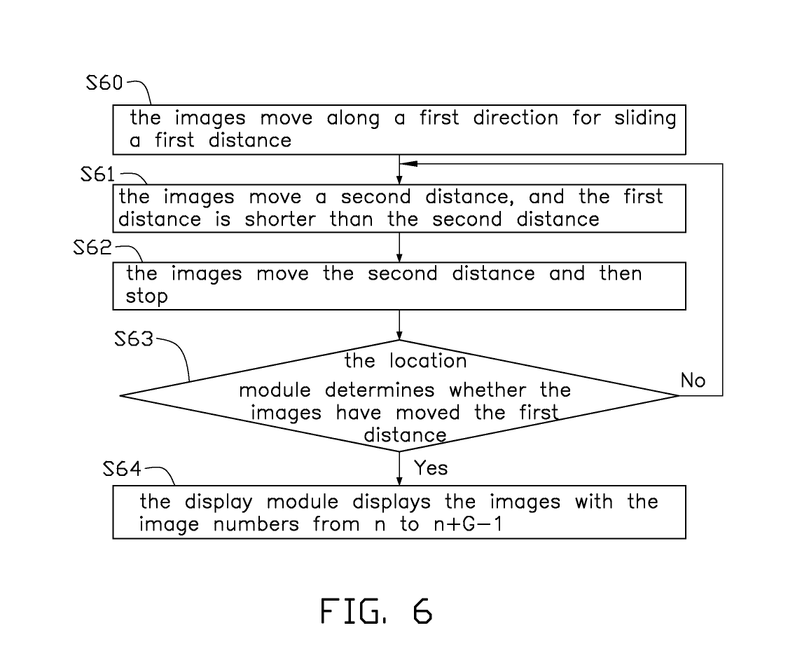

Referring to FIGS. 3-6, one embodiment of a method of browsing images smoothly by an electronic device includes the following blocks.

In block S60, the images move along a first direction for sliding a first distance. In one embodiment, the images are moved towards left. The display 15 will display the images with the image numbers from n to n+G−1. In one embodiment, the image with the image number 4 is display on the middle portion of the display 15 in an initial position. When the user selects the image with the image number 5, the images move towards left. A distance between the images with the image numbers 4, 5 is the first distance. The first distance may be 100 pixels.

In block S61, the images move a second distance, and the first distance is longer than the second distance. In one embodiment, the display 15 has 800*600 pixels. The second distance is 20 pixels. Each time the images moves a second distance, the user would see the images. Thus it would appear as if the images are moving across the screen, as opposed to instantaneous movement.

In block S62, the images move the second distance in a first time and then stop. In one embodiment, the first time is 0.2 seconds.

In block S63, the location module determines whether the images have moved the first distance. If the images have moved the first distance, return S61; if not, go on S64. In one example, the first distance is equal to five second distances. The images must be moved the second distances five times to arrive at the destination. The images move and stop for implementing the animation effect. When the user selects the 5^{th} image, all the images need to be moved toward left. The 5^{th} image will be moved to the position of the 4^{th} image. The first distance is the space between the 4^{th} and 5^{th} images, and the second distance is determined by the location module. All the images are moved a second distance, stopped, and then moved a second distance again until the 5^{th} image is moved to the position of the 4^{th} image. Thus, the user sees the 5^{th} image moved to the position of the 4^{th} image with the animation effect of the images moving across the screen. In one embodiment, the interval of the 4^{th} and 5^{th} images is 100 pixels. Each time the images are moved 20 pixels. Therefore, the images are moved and stop 100/20=5 times to arrive at the destination.

In block S64, the display module displays the images with the image numbers from n to n+G−1. The display module will display new n−1 images on the display 15. In one embodiment, the display module decodes the small images with the image numbers 4, 8 and the big image with the image number 5 for displaying.

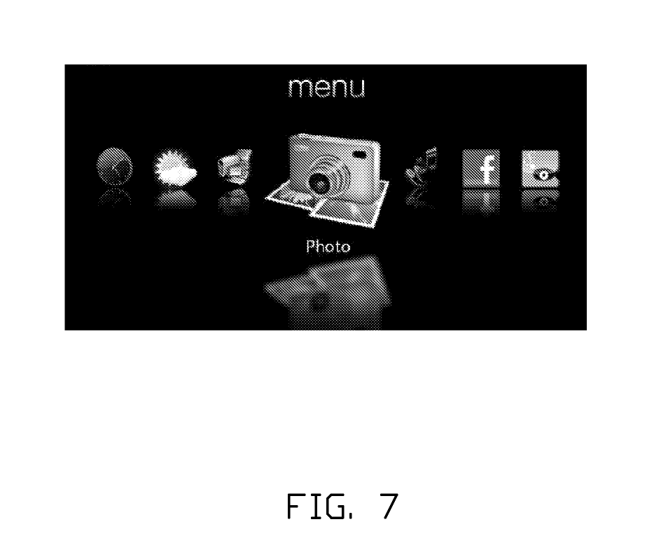

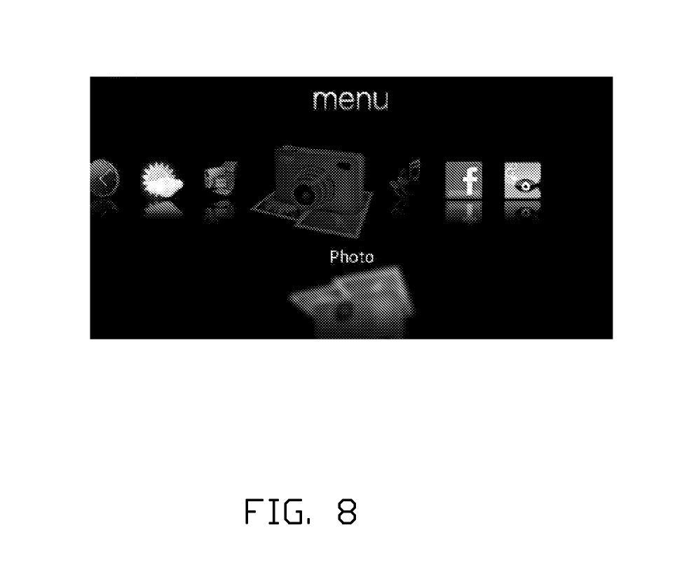

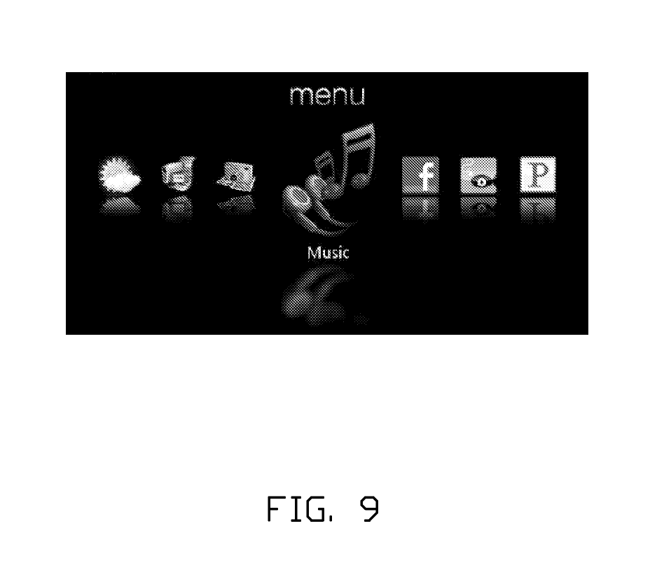

In one embodiment, FIG. 7 shows an enlarged image is displayed on a middle portion of the display 15. The image is a photo icon. Other images are small relative to the photo icon. FIG. 8 shows the display 15 when a user operates a remote controller to select a music icon. All images are moved towards left; however, it is understood images can be moved to the right as well. The display 15 becomes dim so that the user would see all images are sliding. FIG. 9 shows another image is displayed on the display 15 when the images stop sliding. The music icon will be enlarged to display on the middle portion of the display 15. The photo icon will become small.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of browsing images on an electronic device, the method comprising:
confirming a first distance in which an image is desired to be moved;
moving the image a second distance along a first direction and displaying the image, the second distance is shorter than the first distance; and
determining whether the image has moved the first distance, if the image has not moved the first distance, repeating the step of moving the image the second distance.

2. The method of claim 1, wherein the image is a selected image, the selected image is enlarged after the image moves the first distance.

3. The method of claim 2, wherein the electronic device comprises a storage and a display, and the storage loads the enlarged image to the display.

4. The method of claim 3, wherein the storage loads new images to the display after the image moves the first distance.

5. The method of claim 3, wherein the display comprises a plurality of pixels, and the second distance is 20 pixels.

6. The method of claim 3, wherein any image at a middle portion is displayed larger than other images.

7. The method of claim 3, wherein the display dims when the image is in the process of moving the first distance.

8. The method of claim 1, wherein the image is moved the first distance from direction of a remote controller.

9. The method of claim 1, wherein the image is a menu icon.

10. An electronic device capable of browsing images, the electronic device comprising:
an initializing module capable of confirming a first distance an image is desired to be moved;
a location module capable of moving the image a second distance along a first direction and displaying the image, the second distance is shorter than the first distance, the location module is also capable of determining whether the image has moved the first distance, if the image has not moved the first distance, the location module is capable of repeating the step of moving the image the second distance.

11. The electronic device of claim 10, wherein the image is a selected image, and the selected image is capable of being enlarged after the image moves the first distance.

12. The electronic device of claim 11, wherein the electronic device comprises a storage and a display, the storage is capable of loading the enlarged image to the display.

13. The electronic device of claim 12, wherein the storage is capable of loading new images to the display after the image moves the first distance.

14. The electronic device of claim 12, wherein the display comprises a plurality of pixels, and the second distance is 20 pixels.

15. The electronic device of claim 12, wherein the display is capable of displaying any image at a middle portion larger than other images.

16. The electronic device of claim 12, wherein the display is capable of diming when the image is in the process of moving the first distance.

17. The electronic device of claim 10, wherein the image is capable of being moved the first distance by direction of a remote controller.

18. The electronic device of claim 10, wherein the image is a menu icon.
